(19) United States
(12) Patent Application Publication
(10) Pub. No.: US 2006/0208439 A1
(43) Pub. Date: Sep. 21, 2006

(54) Wheeled laundry basket

(76) Inventors: Joseph Depasquale, Leominster, MA (US); Ronald Audet, North Smithfield, RI (US); David Zephir, Westminster, MA (US); Rebecca B. Foster, Columbia, SC (US)

Correspondence Address: Brian M. Dingman, Esq.;Mirick, O'Connell, DeMallie & Lougee, LLP, 1700 West Park Drive, Westborough, MA, 01581, US

(21) Appl. No.: 11/284,594

(22) Filed: Nov. 22, 2005

Related U.S. Application Data
(60) Provisional application No. 60/630,369, filed on Nov. 23, 2004.

(51) Int. Cl. B62B 1/00

(52) U.S. Cl. 280/47.17

(57) ABSTRACT

A wheeled laundry basket with an integral generally rectangular basket member with two longer sides and two shorter ends, and defining an upper rim that has its lowermost portion around the center of the sides, and highest portions at the ends, so that the rim at the ends is capable of being gripped at a point higher than the lowest point of the sides. The basket member defines at least one indentation at the intersection of at least one end and the bottom. There is an axle coupled to the basket member and carrying at least two wheels that are each located at least in part within an indentation and that are either flush with the bottom of the basket member or extend partially below the bottom surface of the basket member.

### CROSS-REFERENCE TO RELATED APPLICATION

This application claims priority of Provisional application Ser. No. 60/630,369, filed Nov. 23, 2004.

### FIELD OF THE INVENTION

This invention relates to a laundry basket/laundry hamper.

### BACKGROUND OF THE INVENTION

Laundry baskets and laundry hampers can be large and bulky. When they are full of clothes, they are heavy, and so can be hard to carry and handle. There is thus a need for a wheeled laundry basket/hamper (generically termed a “basket” herein) that is easier to carry and move around the home.

### SUMMARY OF THE INVENTION

This invention features a wheeled laundry basket that can be easily carried or wheeled by the user. Due to the unique wheel size and placement, and the unique shape of the upper rim of the basket, the basket sits flat like a non-wheeled laundry basket when placed on a flat surface, yet can be lifted at one end and wheeled using wheels located at the bottom corner of the other end.

One preferred embodiment of the invention comprises a wheeled laundry basket with an integral generally rectangular basket member with two longer sides and two shorter ends, and defining an upper rim that is curved from the lowermost portion around the center of the sides, to highest portions at the ends, so that the rim at the ends is capable of being gripped at a point higher than the lowest point of the sides. The basket member defines at least one indentation at the intersection of at least one end and the bottom. There is an axle coupled to the basket member and carrying at least two wheels that are each located primarily within an indentation and that do not extend substantially below the bottom surface of the basket member when the basket member is placed on a flat surface.

The axle may be coupled to the basket member in an indentation. The wheeled laundry basket may comprise an elongated indentation that extends along one end, with an axle and two wheels located in the indentation. The wheels may be made from two different materials. The outer circumferential portion of the wheels may be made from a material that is softer than the central portion that is coupled to the axle.

The wheeled laundry basket may comprise at least one indentation at the intersection of each end and the bottom. The wheeled laundry basket may further comprise a second axle coupled to the basket member, one axle located at each end of the basket. The wheeled laundry basket may further comprise at least two wheels carried by the second axle, the wheels each located primarily within an indentation and not extending substantially below the bottom surface of the basket member when the basket member is placed on a flat surface. The wheeled laundry basket may comprise four indentations, two per side of the basket member, each indentation located at the intersection of an end and a side and the bottom of the basket member, and each located in part on an end and in part on a side and in part in the bottom.

At least one longer side of the basket member may be concave, to define a space for the hip of a user carrying the laundry basket. The wheeled laundry basket may further comprise a handle on each of the four sides of the basket member, each handle defined by an opening located below the basket rim.

### BRIEF DESCRIPTION OF THE DRAWINGS

Other objects, features and advantages will occur to those skilled in the art from the following description of the preferred embodiments, and the accompanying drawings, in which:

FIG. 1 is a perspective view of one preferred embodiment of the laundry basket of the invention;

FIG. 2 is a partial side view of the laundry basket of FIG. 1;

FIG. 3 is a bottom perspective view of the laundry basket of FIG. 1;

FIG. 4 is a close-up view of the axle and wheels of the laundry basket of FIG. 1;

FIG. 5 shows the laundry baskets of FIG. 1 nested for storage and retail display;

FIG. 6 is a perspective view of another preferred embodiment of the laundry basket of the invention;

FIG. 7 is a partial, perspective view of yet another preferred embodiment of the laundry basket of the invention;

FIG. 8 is a partial top view of a laundry basket of the invention, detailing the preferred side shape; and

FIG. 9 is an elevational view of the preferred wheel construction for the laundry basket of this invention.

### DETAILED DESCRIPTION OF THE PREFERRED EMBODIMENTS OF THE INVENTION

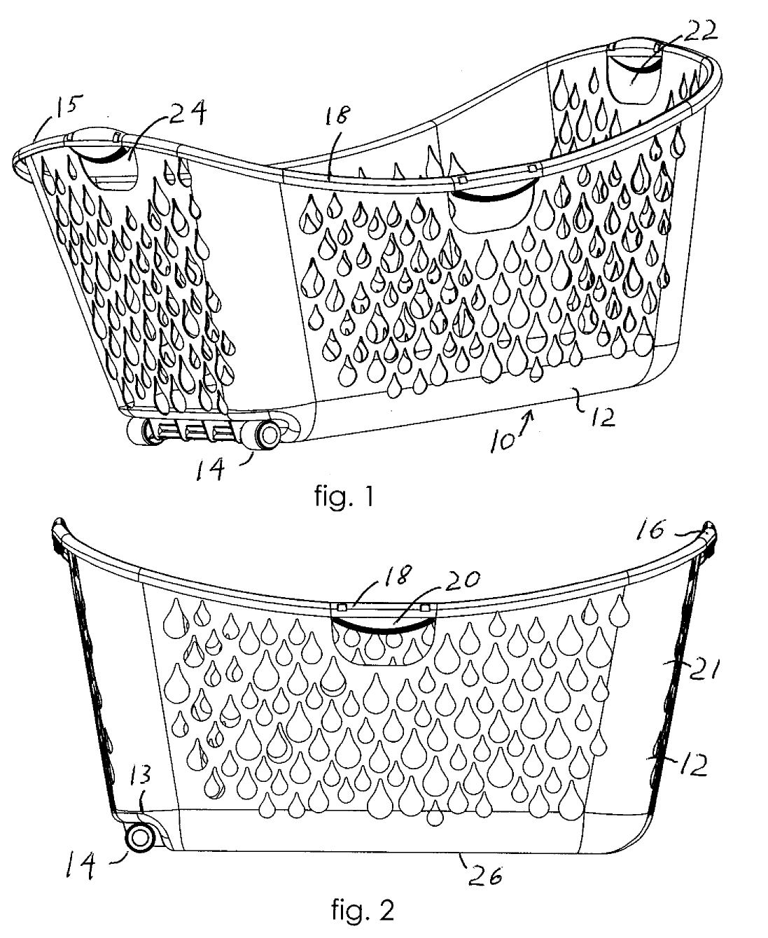

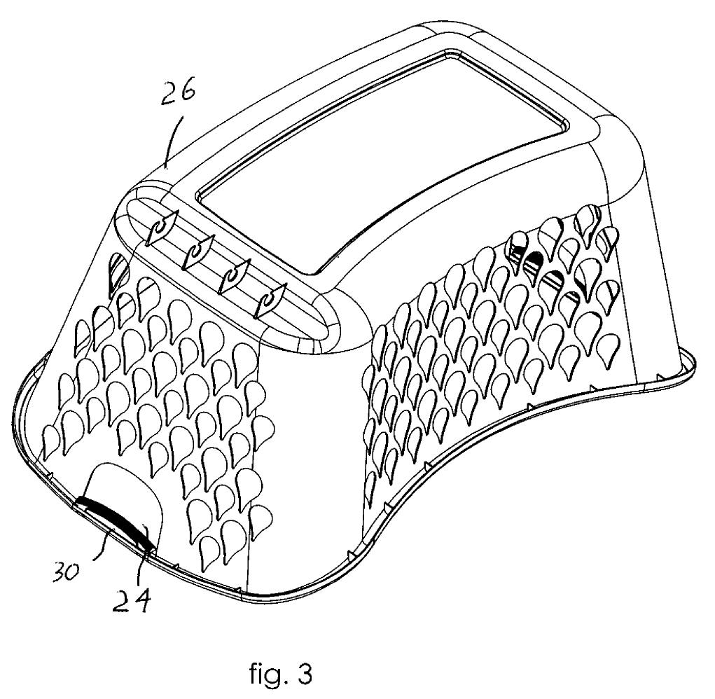

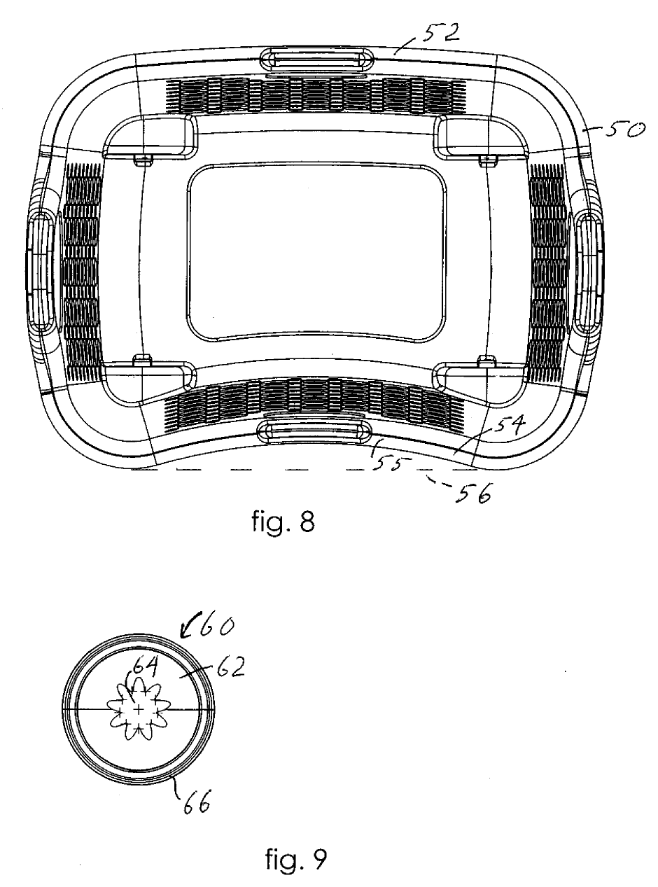

One preferred embodiment of the invention is shown in the attached FIGS. 1-5. Wheeled laundry basket 10 includes integral injection-molded plastic basket member 12 and wheel-carrying axle 14 carried by basket member 12. Upper rim 18 of basket member 12 is gently curved up towards both ends 15 and 16. The handles defined by openings 22 and 24 that are just below the top rim 18 are somewhat elevated relative to the lowest point of rim 18. In the preferred embodiment of basket 10 (as a non-limiting example of the invention), the lowest point of the rim is approximately 10″ high, and the ends are approximately 13″ high. Opening 20 along side 21 creates a third handle that can be held by one hand when the basket is held against the user's hip. In a preferred embodiment, one long side has a generally concave shape as shown in FIG. 8 and described below.

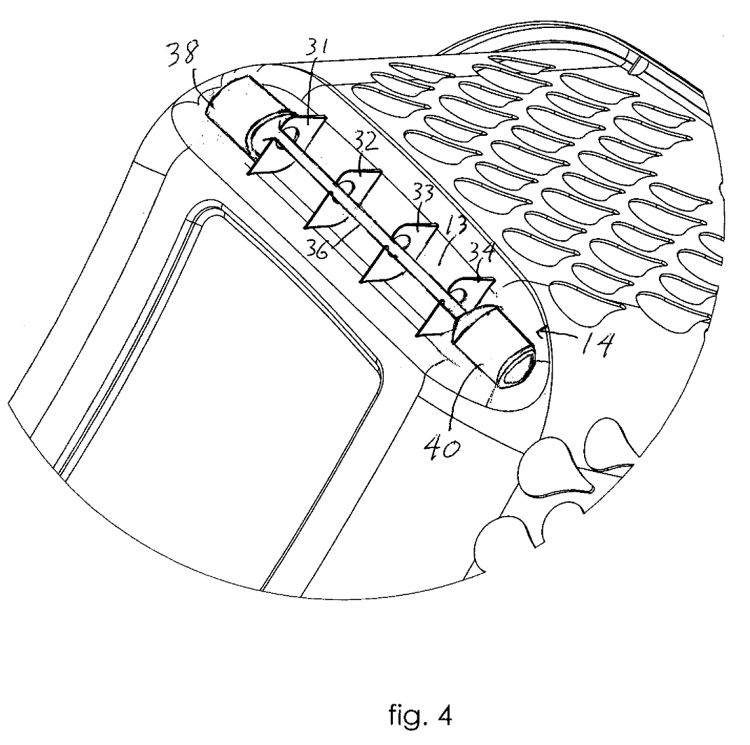

Wheeled axle 14 may be coupled to basket 12 by a mechanical snap fit into openings molded into supports 31 to 34, as best shown in FIG. 4. The axle could be accomplished in other manners. For example, the axle could be accomplished with stubs molded into the appropriate portions of the basket member or the wheels. Wheels 38 and 40 rotate relative to axle 36, or if the axle is integral with the wheel, the wheel and axle rotate relative to the basket. Wheels 38 and 40 typically have a diameter of about one inch and a length of about 1.25 inches, although these dimensions are not a limitation of the invention.

As best shown in FIGS. 2 and 4, basket member 12 is preferably molded to define an elongated indentation 30 in one corner (at the intersection of one end and the bottom) in which axle 14 nests. The arrangement is preferably accomplished such that wheels 38 and 40 are about flush with the ground, so that they do not extend substantially below the lower surface 26 of basket member 12 when the basket is placed on a flat surface. When end 16 is lifted (typically in the range of 4 to 10 inches off the ground) by grasping handle 22, the far end of the bottom is lifted off the ground such that wheels 38 and 40 are the only members which contact the ground. This construction allows the basket to be wheeled without the need for an extending/retracting handle member, or wheels that extend much if at all below the base of the basket when the basket sits on a flat surface. Raised end 15 helps to prevent laundry from spilling out of the basket when end 16 is raised during this wheeling action.

The handles can include an integral (or separate) member such as member 30 located essentially underneath rim 18. Member 30 presents a generally curved profile to make the grip more comfortable. This assists in the user's comfort both in carrying and wheeling the laundry basket.

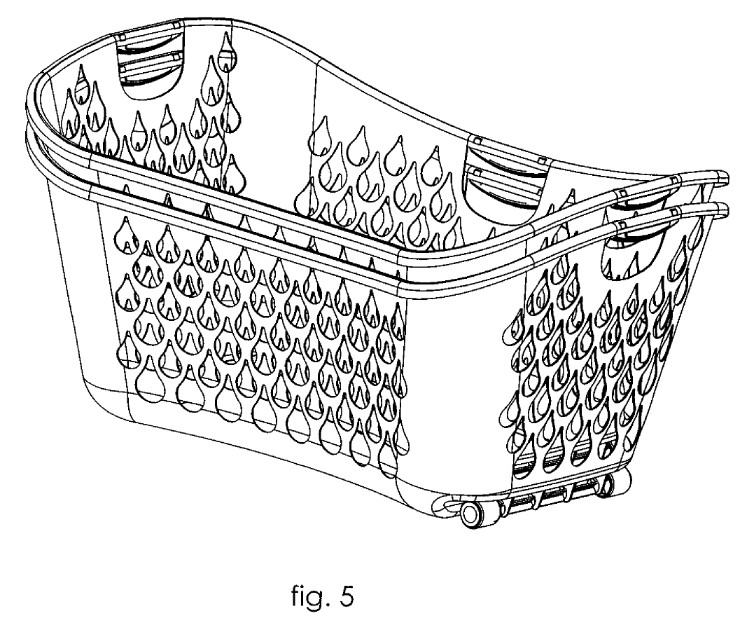

As shown in FIG. 1, basket member 12 is preferably designed with all four sides being slightly tapered inwardly from the top towards the bottom to create an open top that is larger than bottom 26, FIG. 2. This allows the laundry baskets to be nested as shown in FIG. 5, which simplifies both the shipping and retail display of the laundry basket.

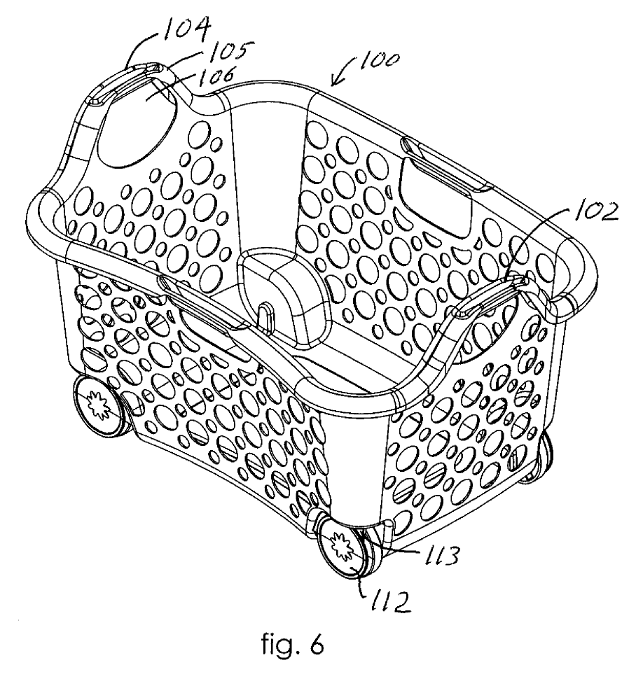

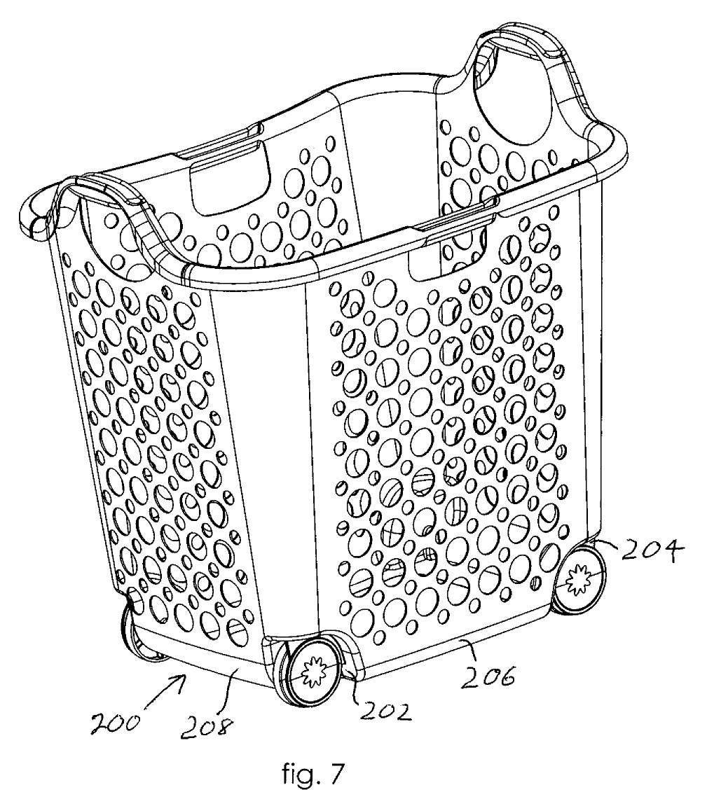

The basket member can be of any convenient shape and size. Preferably, the shape is generally rectangular as shown in all of the drawings. Two larger-size baskets 100 and 200 are shown in FIGS. 6 and 7, respectively. These figures also show a different manner of accomplishing the wheeling aspect of the inventive basket. In one aspect, the indentations in which the wheels are located can be accomplished with a separate indentation for each wheel, as shown in these drawings. For example, indentation 202, FIG. 7, is located at the intersection of the bottom, end 206 and side 208. Indentations 202 and 204 are each located in part in an end, in part in an adjacent side, and in part in the bottom.

Another aspect is wheels 112, FIG. 6. Four such wheels, one at each comer, are used in these two embodiments. In these embodiments with four wheels, the wheels preferably extend below the basket body by about one-half inch, so that the wheels support the basket when the basket is placed on a flat surface. These wheels can be molded with integral short stubs that act as axles and that snap-fit into the body of the basket in any convenient manner, such as by fitting into extending tab portion 113. The preferred wheel construction is shown in FIG. 9, in which wheel 60 has integral hub portion 62 and axle 64. Outer surface portion 66 is made of a softer material than is hub portion 62/axle 64, to keep the wheels quieter and also help prevent damage to floors caused by the wheels.

FIG. 8 shows the preferred top rim shape. Rim 50 includes longer sides 52 and 54. One side 54 is slightly concave, as shown by the difference in location between central portion 55 and the location 56 in which portion 55 would be located if side 54 was parallel to side 52. The slight indentation makes the basket easier to carry on the user's hip, while holding the handle located along side 52.

Although specific features of the invention are shown in some drawings and not others, this is for convenience only as the features may be combined in accordance with the invention.

Other embodiments will occur to those skilled in the art and are within the following claims.

What is claimed is:

1. A wheeled laundry basket, comprising:
an integral generally rectangular basket member with two longer sides and two shorter ends, and defining an upper rim that has its lowermost portion along the sides, and highest portions at the ends, so that the rim at the ends is capable of being gripped at a point higher than the lowest point of the sides;
wherein the basket member defines at least one indentation at the intersection of at least one end and the bottom;
an axle coupled to the basket member; and
at least two wheels carried by the axle, the wheels each located primarily within an indentation and not extending substantially below the bottom surface of the basket member when the basket member is placed on a flat surface.

2. The wheeled laundry basket of claim 1 wherein the axle is coupled to the basket member in an indentation.

3. The wheeled laundry basket of claim 1 comprising an elongated indentation that extends along one end, with an axle and two wheels located in the indentation.

4. The wheeled laundry basket of claim 1 wherein the wheels are made from two different materials.

5. The wheeled laundry basket of claim 4 wherein the outside circumferential portion of the wheels is made from a material that is softer than the central portion that is coupled to the axle.

6. The wheeled laundry basket of claim 1 comprising at least one indentation at the intersection of each end and the bottom.

7. The wheeled laundry basket of claim 6 further comprising at least a second axle coupled to the basket member, with at least one axle located at each end of the basket.

8. The wheeled laundry basket of claim 7 further comprising at least two wheels at each end of the basket, the wheels each located within an indentation.

9. The wheeled laundry basket of claim 8 comprising four indentations, two per side of the basket member, each indentation located at the intersection of an end and a side and the bottom of the basket member, and each located in part on an end and in part on a side and in part in the bottom.

10. The wheeled laundry basket of claim 9, wherein each wheel comprises an integral axle that is mechanically coupled to the basket member.

11. The wheeled laundry basket of claim 1 wherein at least one longer side of the basket member is concave, to define a space for the hip of a user carrying the laundry basket.

12. The wheeled laundry basket of claim 11 further comprising a handle on each of the four sides of the basket member, each handle defined by an opening located below the basket rim.

13. A wheeled laundry basket, comprising:
an integral generally rectangular basket member with two longer sides and two shorter ends, and defining an upper rim that has its lowermost portion along the sides, and highest portions at the ends, so that the rim at the ends is capable of being gripped at a point higher than the lowest point of the sides;
wherein the basket member defines at least one indentation at the intersection each end and the bottom; and
four wheels, each carried by an axle, the wheels each located in part within an indentation and extending somewhat below the bottom surface of the basket member when the basket member is placed on a flat surface, wherein the wheels are made from two different materials, the outside circumferential portion of the wheels made from a material that is softer than the central portion.

14. The wheeled laundry basket of claim 13 comprising at least one indentation at the intersection of each end and the bottom.

15. The wheeled laundry basket of claim 14 wherein the axles are integral with the wheels.

16. The wheeled laundry basket of claim 15 comprising four indentations, two per side of the basket member, each indentation located at the intersection of an end and a side and the bottom of the basket member, and each located in part on an end and in part on a side and in part in the bottom.

17. The wheeled laundry basket of claim 13 wherein at least one longer side of the basket member is concave, to define a space for the hip of a user carrying the laundry basket.

18. The wheeled laundry basket of claim 17 further comprising a handle on each of the four sides of the basket member, each handle defined by an opening located below the basket rim.
